(19) United States
(12) Patent Application Publication
(10) Pub. No.: US 2014/0178535 A1
(43) Pub. Date: Jun. 26, 2014

(54) COATING COMPOSITIONS FOR CONSUMABLE ARTICLES

(71) Applicant: Tate & Lyle Ingredients Americas LLC, Hoffman Estates, IL (US)

(72) Inventors: Melissa Kirby Riddell, South Elgin, IL (US); Shawn E. Sprankle, Elgin, IL (US)

(21) Appl. No.: 14/195,365

(22) Filed: Mar. 3, 2014

Related U.S. Application Data
(63) Continuation-in-part of application No. PCT/US2013/076805, filed on Dec. 20, 2013.
(60) Provisional application No. 61/740,273, filed on Dec. 20, 2012.

(51) Int. Cl. A23G 3/34

(52) U.S. Cl. CPC A23G 3/343
USPC 426/94; 426/572; 426/548; 426/89; 426/93; 426/103; 426/100; 426/302

(57) ABSTRACT

Compositions comprised of water, at least one sweetening agent and at least one food grade emulsifier/foaming agent are useful for forming frosted sweet coatings on consumable articles. The inclusion of a food grade emulsifier/foaming agent in such a composition helps to render the dried coating obtained therefrom more opaque in appearance, even though the sucrose content may be relatively low.

### CROSS-REFERENCE TO RELATED APPLICATIONS

This application is a continuation-in-part of International Application No. PCT/US2013/076805, filed 20 Dec. 2013, which claims priority from U.S. Provisional Application No. 61/740,273, filed 20 Dec. 2012. The entire disclosure of each of the aforementioned applications is incorporated herein by reference in its entirety for all purposes.

### FIELD OF THE INVENTION

The present invention relates to compositions useful for forming opaque, sweet-tasting coatings on consumable articles.

### BACKGROUND OF THE INVENTION

Many food products, such as baked goods and ready-to-eat cereals, include an outer coating which is comprised mostly of sugar (sucrose). Such coatings may serve multiple purposes, including, for example, providing cereals with longer bowl life, imparting a crispy but non-brittle texture to the food product, and giving the surface of the food product a frosted, opaque appearance that consumers find appealing. Outer coatings of this type additionally provide enhanced sweetness and taste as compared to the uncoated food product, which typically is grain-based and has a relatively low sugar content.

Opaque (frosted) coatings on food products have conventionally been obtained by applying a layer of an aqueous composition having a high sucrose content (such as a sucrose syrup) to the surface of the food product and then drying the aqueous composition layer. The crystallization of sucrose which takes place upon drying is primarily responsible for the opacity of the dried coating. As the sucrose content of such an aqueous composition is reduced (due to the introduction of other sweetening agents), the dried coatings obtained generally tend to have a glazed or translucent, rather than fully opaque, appearance, since sweetening agents other than sucrose typically have a lower propensity than sucrose to crystallize. The presence of sweetening agents other than sucrose in combination with sucrose in such coating compositions may also interfere with the ability to obtain a fully opaque (frosted) dried coating due to inhibition of sucrose crystallization by such other sweetening agents. These issues have proven to be challenging for food processors seeking to manufacture sweet-coated food articles where the sweet coating needs to be opaque, but with a reduced content of sucrose as compared to conventional “frosted” coatings. Such food processors, for cost reduction reasons and/or the desire to use certain sweetening agent sources (e.g., brown sugar, honey) for the flavor attributes they can provide to the finished food product, would be interested in the development of alternative coating compositions that do not require the use of high levels of sucrose and yet still create dried coatings of high opacity. Additionally, food processors would be desirous of coating systems that permit sucrose-based compositions to be used in lower amounts in order to achieve a preselected degree of opacity in a coating as compared to conventional sucrose-based compositions (thereby reducing costs and/or permitting the overall sugar content of the coated product to be reduced, while still providing a coated product that has a fully opaque, and thus visually appealing, coating of sweetener).

### BRIEF SUMMARY OF THE INVENTION

Combining a food grade emulsifier/foaming agent with water and at least one sweetening agent has been discovered to provide a composition which when coated onto a consumable article and dried results in a sweet-tasting coating which is more opaque (frosted) in appearance than an analogous coating obtained in the absence of the emulsifier/foaming agent. That is, incorporating the food grade emulsifier/foaming agent into an aqueous composition containing at least one sweetening agent improves the opacity of a dried coating of the aqueous composition. The present invention thus makes possible the substitution (in whole or in part) of sweetening agents other than sucrose for the sucrose conventionally used in sweet coating formulations, without compromising the ability of the formulations to provide an opaque coating when dried on the surface of a consumable article. Additionally, the present invention permits the amount of a sucrose-based coating composition that must be applied to a food article in order to attain a dried coating having a preselected degree of opacity to be reduced, as a result of the inclusion of a food grade emulsifier/foaming agent.

One aspect of the invention provides a composition useful for forming an opaque coating on a consumable article, wherein the composition is comprised of water, at least one sweetening agent, and at least one food grade emulsifier/foaming agent.

The composition may, in various aspects, either comprise no sucrose or comprise sucrose in an amount which is insufficient to render opaque a coating of the composition when dried on a consumable article in the absence of the at least one food grade emulsifier/foaming agent.

In one aspect, the at least one sweetening agent includes at least one high intensity sweetener, which may be a natural and/or synthetic high intensity sweetener.

In another aspect, the at least one sweetening agent may include at least one mono-and/or di-saccharide.

In other aspects, the at least one sweetening agent may include at least one polyol and/or oligomeric saccharide.

In another aspect, the at least one sweetening agent includes at least two sweetening agents selected from the group consisting of high intensity sweeteners, mono-saccharides, di-saccharides, polyols, oligomeric saccharides and combinations thereof.

In a further aspect, the composition may be comprised of at least one syrup selected from the group consisting of sucrose syrups, glucose syrups, fructose syrups, corn syrups, high fructose corn syrups, brown sugar syrups, molasses, honey and combinations thereof.

In other aspects of the invention the composition may be essentially free of fatty substances and/or gums.

In another aspect, the composition may be in the form of a slurry.

In another aspect, the composition does not comprise an emulsion.

The food grade emulsifier/foaming agent may be a modified starch, in one aspect of the invention.

In one aspect of the invention, the composition may comprise from about 0.1 to about 10% by weight of food grade emulsifier/foaming agent.

The food grade emulsifier/foaming agent may be a lipophilic starch, according to one aspect of the invention.

In yet a further aspect of the invention, the food grade emulsifier/foaming agent may be a lipophilic starch obtained by reacting starch with octenyl succinic anhydride.

Also provided by the present invention is a consumable article having an opaque coating comprised of a dried composition in accordance with any of the aforementioned aspects of the invention.

The consumable article, in various aspects of the invention, may be selected from the group consisting of cereals, breakfast bars, granola bars, doughnuts, baked goods, energy bars, trail mixes, granolas, frozen dairy products, and confectioneries.

Additionally contemplated by the present invention is a method of making a sweet-coated consumable article, comprising applying a layer comprised of a coating composition in accordance with any of the aforementioned aspects on a surface of a consumable article and drying the layer.

Another aspect of the invention provides a method of rendering a coating composition comprised of water and at least one sweetening agent more opaque in appearance when applied to a surface of a consumable article and dried, wherein the method comprises formulating the coating composition to include at least one food grade emulsifier/foaming agent.

### DETAILED DESCRIPTION OF THE INVENTION

The coating compositions of the present invention comprise water and at least one sweetening agent, together with one or more food grade emulsifiers/foaming agents which assist in rendering the coating composition opaque in appearance when the composition is applied as a layer on a consumable article and then dried. In one embodiment, the water and at least one of the sweetening agents may be supplied to the coating composition in the form of a syrup. In another embodiment, the water and sweetening agent may be provided separately. Other such variations and combinations thereof are also contemplated to be within the scope of the present invention. For example, the coating composition may comprise two sweetening agents, wherein a syrup comprising water and one of the sweetening agents and the other sweetening agent are combined with the one or more food grade emulsifiers/foaming agents to provide the coating composition. If a sweetening agent is provided in the form of a syrup, an additional quantity of water (besides the water present in the syrup) may be combined with the other ingredients to arrive at the coating composition.

In one embodiment of the invention, the syrup or syrups used as a component of the coating composition may be any of the sweetener syrups known in the art such as, for example, sucrose syrups, glucose (dextrose) syrups, fructose syrups, corn syrups, high fructose corn syrups, brown sugar syrups, molasses, honey and combinations thereof. Such syrups may be combined with the food grade emulsifier/foaming agent(s) and other components of the coating composition in syrup form. Alternatively, a dried syrup composition (e.g., dried syrup solids, such as corn syrup solids) may be simultaneously or sequentially combined with water, the food grade emulsifier/foaming(s) and other components to obtain coating compositions in accordance with the present invention.

Suitable sweetening agents for use in the coating compositions include any of the natural saccharides having a sweet taste when consumed, such as mono- and disaccharides. These naturally occurring saccharides include both the common sugars as well as the so-called rare sugars (such as allulose, sorbose and tagatose). Such saccharides may be obtained from natural sources by isolation and purification or may be produced by conversion of other saccharides (e.g., by enzyme treatment). Exemplary suitable natural saccharides include, without limitation, sucrose, glucose (dextrose), fructose, maltose, lactose, trehalose, allulose, sorbose, tagatose and combinations thereof. Oligomeric saccharides, such as oligosaccharides having a degree of polymerization of from 3 to 10 for example, may also be used; in one embodiment, such oligomeric saccharides are used in combination with mono- and/or di-saccharides.

Non-saccharide sweetening agents such as polyols (e.g., sugar alcohols) are also useful in the present invention. Examples of suitable polyols include, without limitation, lactitol, xylitol, erythritol, sorbitol, maltitol, mannitol, glycerol, arabitol and combinations thereof. Combinations of non-saccharide and saccharide sweetening agents may be utilized.

The sweetening agent may have a level of perceived sweetness lower than, approximately the same as, or greater than that of sucrose. For example, high intensity (high potency) sweeteners (including both natural and synthetic sweeteners) may be used, either alone or in combination with other types of sweetening agents. In one embodiment of the invention, the coating composition contains one or more high intensity (high potency) sweetening agents having a sweet taste that is more intense (on an equal weight concentration basis) than sucrose. Such high intensity sweetening agents may be employed to advantage in order to reduce the caloric content of the coating composition (as compared to that of an analogous coating composition based on sucrose as the sole sweetening agent) and/or to boost the perceived sweetness of the coating composition (due to the presence of one or more low intensity sweetening agents having a level of perceived sweetness less than that of sucrose).

Suitable natural high intensity sweetening agents include, but are not limited to, glycosides such as mogrosides (such as mogroside IV and mogroside V), steviol glycosides (such as rebaudioside A, rebaudioside B, rebaudioside C, rebaudioside D, rebaudioside E, rebaudioside F, stevioside, dulcoside A, dulcoside B, steviolmonosides, and steviolbiosides), siamenoside and rubusoside. Purified extracts containing such natural high intensity sweetening agents may be utilized, such as Luo Han Guo (monk fruit) extracts and Stevia extracts. Other suitable natural sweetening agents include brazzein, curculin, glycyrrhizin (glycyrrhizic acid) and its salts, mabinlin, monatin and its salts, monellin, pentadin, thaumatin, hernandulcin, phyllodulcin, glycyphyllin, phloridzin and the like. Suitable natural high intensity sweetening agents also include modified sweetening agents which have been altered naturally or synthetically such as by fermentation, contacting with enzyme, or derivatization or substitution.

Suitable synthetic high intensity sweetening agents include, but are not limited to, sucralose, saccharin, cyclamate, acesulfame potassium, neotame, aspartame, neohesperidin dihydrochalcone, alitame and the like.

Suitable emulsifiers/foaming agents useful in the present invention include any of the substances approved for, or acceptable for use in, food products that have emulsifying and/or foaming characteristics (i.e., substances that are capable of emulsifying or foaming a composition when included in such composition). Particularly suitable for use in the present invention are modified starches, including lipophilic starches. Lipophilic starches may be prepared by reacting starch with a reagent which introduces lipophilic (hydrophobic) groups such as hydrocarbon chains (e.g., aliphatic groups containing, for example, 4 to 18 carbon atoms, which may be saturated or unsaturated) onto the backbone of a starch molecule through esterification reactions or the like. The resulting modified starch contains both lipophilic and hydrophilic segments. For example, a suitable lipophilic starch may be obtained by reacting starch with an organic acid anhydride such as octenyl succinic anhydride or the like. Lipophilic starches are well known in the art and are readily available from commercial sources, including from Tate & Lyle under the brand names MIRAMIST and MIRACAP. Octenyl succinate anhydride starch (obtained by reacting starch with octenyl succinate anhydride) is a particularly suitable lipophilic starch. Methods of making lipophilic starches (sometimes referred to as lipophilic modified starches) are described, for example, in U.S. Pat. Nos. 2,661,349; 4,035,235; 5,672,699; and 6,037,466 as well as in U.S. Pat. Publication No. 2011/0287165, each of which is incorporated herein by reference in its entirety for all purposes. Lipophilic starches are also described in the following treatises: “Starch: Chemistry and Technology,” Second Edition, edited by R. L. Whistler et al., 1988, pp. 341-343; and “Modified Starches—Properties and Uses,” edited by O. Wurzburg, 1986, Chapter 9, pp. 131-147.

Generally speaking, an amount of food grade emulsifier/foaming agent (which can be either a single emulsifier/foaming agent or a mixture of emulsifiers/foaming agents) is included in the coating composition which is effective to increase the opacity of the coating composition when applied as a coating and dried. Typically, suitable amounts for such purpose are about 0.1 to about 10% by weight of the coating composition.

An amount of water is additionally present in the coating composition which is effective to render the composition sufficiently liquid and flowable to permit it to be applied as desired to the surface of a consumable article. Generally speaking, it will be advantageous to avoid the use of excessive amounts of water, in order to help reduce drying times, utility costs and so forth. For example, the coating composition may contain from about 10% to about 40% by weight water or from about 20% to about 35% by weight water.

The coating compositions of the present invention may further comprise, in addition to the water, sweetening agent(s) and the food grade emulsifier/foaming agent(s), one or more additional ingredients such as, for example, vitamins, preservatives, stabilizers, pH adjusting agents, colorants, flavors (flavorants), fragrances, triglycerides (oils, fats), thickeners, rheology control agents, protein sources, flavor/taste enhancers (including sweetness enhancers and modifiers that are not themselves sweetening agents) and the like. However, in one embodiment of the invention, the coating composition is essentially free or entirely free of any fatty substance (fats, oils, etc.). For example, the coating composition may comprise not more than 0.5% by weight or not more than 0.1% by weight fatty substances. In another embodiment, the coating composition is essentially free or entirely free of any proteinaceous substance. For example, the coating composition may comprise not more than 0.5% by weight or not more than 0.1% by weight proteinaceous substances. In another embodiment, the coating composition is essentially free or entirely free of any gum. For example, the coating composition may comprise not more than 0.5% by weight or not more than 0.1% by weight gums.

In one embodiment, the coating composition is in the form of a slurry. The liquid phase of the slurry may, for example, comprise water and sweetening agent(s) dissolved in the water. The solid phase of the slurry may, for example, comprise the emulsifier/foaming agent(s). In another embodiment, the coating composition does not comprise an emulsion.

The coating compositions of the present invention can be used to coat a wide variety of consumable articles, including various food products, that typically have a sugar coating or icing. Typically, such food products are in solid (dry) form and are grain-based. These products include, but are not limited to, all types of ready to eat cereal (including flaked cereals, puffed cereals, cereal clusters and extruded cereals); granola type products and so called trail mixes; energy bars and granola bars; baked goods such as cookies, cakes, pies, crackers, pastries and muffins; frozen dairy products such as ice cream cakes and ice cream novelties; confectioneries (candy); nuts and other such foods. The coating compositions of the present invention can enhance the white colored frosted (opaque) appearance of the product. The addition of a food grade emulsifier/foaming agent to a sweetener syrup helps to improve the opaque appearance of the sweetener syrup when applied as a coating to a consumable article and dried. The coating compositions of the present invention may also be used to adhere cereal particles together to form cereal clusters, with the clusters having a frosted appearance.

The coating composition may be applied to the consumable article by any method known in the art. In one embodiment, the coating composition is sprayed onto the consumable article to form a coating. The coating formed may be foamed (i.e., in the form of a foam). Agitation, frothing and other techniques known in the art for incorporating gas, in the form of small bubbles, into a liquid medium may be utilized to generate such a foam. The composition can be provided in the form of a slurry or solution that is sprayed through a spray nozzle to coat the consumable article. In other embodiments, the composition is tumbled, extruded, brushed, knife-coated or roller-coated onto a surface of the consumable article. The composition may be heated to a temperature above room temperature during application so as to improve the flow or other characteristics of the composition. The thickness, coverage and pattern of the applied coating may each be varied as desired to meet consumer preferences or manufacturer needs. For example, the coating may fully or only partially cover the surface of the consumable article. The applied coating may be dried to remove sufficient moisture to provide a solid, adherent coating on the consumable article. For example, the layer of coating composition on the consumable article may be dried to a moisture content of 5% by weight or less. In one embodiment, the coating is dried to a moisture content effective to render the dried coating non-tacky at room temperature. Drying may be facilitated or accelerated by any conventional technique, such as heating and/or induced air flow. Prior to drying, sprinkles, seasonings or other toppings can be applied to the consumable article, on top of the layer of the coating composition. In one embodiment, the components of the coating composition are selected such that when the composition is dried on a consumable article, the surface of the resulting coating is non-tacky at room temperature. In still other embodiments, the present coating compositions can be provided in a discrete or separate package for application to the consumable article by the consumer. For example, the composition can be provided in a form suitable for use as an icing for application to a baked good such as a toaster strudel. In this embodiment, the composition can be disposed within suitable packaging (e.g., fabricated from a moisture barrier flexible packing film fabricated into a pouch) and provided as a component of a kit article comprising the consumable article, the coating composition and instructions for use or application of the coating composition.

### EXAMPLES

To demonstrate the advantages of the present invention, syrup slurries corresponding to the examples listed in Table 1 were prepared.

TABLE 1

| | | | Syrup Brix | |
|---|---|---|---|---|
| | | Lipophilic | (after | Slurry |
| Example | Syrup | Starch | heating) | Appearance |
| 1 (Control) | Krystar ® | None | 77 | No foaming |
| | Liquid | | | |
| 2 (Invention) | Krystar ® | Mira-Mist ® | 77 | Slight |
| | Liquid (97% | 662 (3% | | foaming |
| | by weight) | by weight) | | |
| 3 (Control) | Staleydex ® | None | 71 | No foaming |
| | 130 | | | |
| 4 (Invention) | Staleydex ® | Mira-Mist ® | 72 | Slight to |
| | 130 (97% | 662 (3% | | moderate |
| | by weight) | by weight) | | foaming |

Krystar® Liquid is a pure (99.5+%) fructose syrup containing about 77% solids sold by Tate & Lyle. Staleydex® 130 is a glucose syrup containing about 70% solids sold by Tate & Lyle.

The syrup slurries of Table 1 were prepared in accordance with the following procedure:
1) Weigh syrup (liquid sweetener) and lipophilic starch (if used).
2) Thoroughly mix lipophilic starch (if used) into liquid sweetener at room temperature.
3) Heat mixture to 200° F.±5° F. with moderate agitation with wire whisk. Record any foaming observations.
4) Measure brix using refractometer and record results.
5) Weigh slurry into tared sprayer canister and record weight.
6) Seal canister with lid and open pressure valve to 40 psi.
   The following procedures were used to apply the slurries:
1) Lay waxy paper onto perforated half sheet pan and spray slurry onto paper.
2) Turn off pressure valve and remove canister lid and allow excess slurry to drain.
3) Weigh tared canister with remaining slurry and record value.
4) Dry in convection oven at 285 F on low fan speed. Be sure that paper is secured to pan.
5) Bake for 4 minutes.
6) Record tackiness and opaqueness of coating.

The results obtained, which are shown in Table 2, demonstrate that the incorporation of a lipophilic starch into a low sucrose syrup provides a composition which when dried onto the surface of a substrate is opaque and frosted in appearance.

TABLE 2

| | Initial | Final | Slurry | |
|---|---|---|---|---|
| | Slurry Wt. | Slurry Wt. | Applied | Final |
| Example | (grams) | (grams) | (%) | Observations |
| 1 (Control) | 370.36 | 351.32 | 5.14 | Dried completely; |
| | | | | no tackiness; |
| | | | | completely clear |
| | | | | in appearance |
| | | | | and brittle on |
| | | | | wax paper |
| 2 (Invention) | 361.92 | 337.73 | 6.68 | Dried completely; |
| | | | | slightly tacky; |
| | | | | opaque or frosty |
| | | | | in appearance; |
| | | | | brittle on |
| | | | | wax paper |
| 3 (Control) | 363.45 | 328.14 | 9.72 | Dried completely; |
| | | | | no tackiness; |
| | | | | completely clear |
| | | | | in appearance |
| | | | | and brittle on |
| | | | | wax paper |
| 4 (Invention) | 360.93 | 333.62 | 7.57 | Dried completely; |
| | | Dried completely; | | no tackiness; |
| | | slightly tacky; | | opaque or frosty |
| | | opaque or frosty | | in appearance; |
| | | in appearance; | | brittle on |
| | | brittle on | | wax paper |
| | | wax paper | | |

What is claimed is:

1. A composition useful for forming an opaque coating on a consumable article, wherein the composition is comprised of water, at least one sweetening agent, and at least one food grade emulsifier/foaming agent.

2. The composition of claim 1, wherein the composition either comprises no sucrose or comprises sucrose in an amount which is insufficient to render opaque a coating of the composition when dried on a consumable article in the absence of the at least one food grade emulsifier/foaming agent.

3. The composition of claim 1, wherein the at least one sweetening agent includes at least one high intensity sweetener.

4. The composition of claim 1, wherein the at least one sweetening agent includes at least one mono- and/or di-saccharide.

5. The composition of claim 1, wherein the at least one sweetening agent includes at least one polyol and/or oligomeric saccharide.

6. The composition of claim 1, wherein the composition is comprised of at least one syrup selected from the group consisting of sucrose syrups, glucose syrups, fructose syrups, corn syrups, high fructose corn syrups, brown sugar syrups, molasses, honey and combinations thereof.

7. The composition of claim 1, wherein the composition is essentially free of fatty substances.

8. The composition of claim 1, wherein the composition is essentially free of gums.

9. The composition of claim 1, wherein the composition is in the form of a slurry.

10. The composition of claim 1, wherein the composition does not comprise an emulsion.

11. The composition of claim 1, wherein the food grade emulsifier/foaming agent is a modified starch.

12. The composition of claim 1, wherein the composition comprises from about 0.1 to about 10% by weight of food grade emulsifier/foaming agent.

13. The composition of claim 1, wherein the food grade emulsifier/foaming agent is a lipophilic starch.

14. The composition of claim 1, wherein the food grade emulsifier/foaming agent is a lipophilic starch obtained by reacting starch with octenyl succinic anhydride.

15. A consumable article having an opaque coating comprised of a dried composition in accordance with claim 1.

16. The consumable article of claim 15, wherein the consumable article is selected from the group consisting of cereals, breakfast bars, granola bars, doughnuts, baked goods, energy bars, trail mixes, granolas, frozen dairy products, and confectioneries.

17. A method of making a sweet-coated consumable article, comprising applying a layer comprised of a coating composition in accordance with claim 1 on a surface of a consumable article and drying the layer.

18. A method of rendering a coating composition comprised of water and at least one sweetening agent more opaque in appearance when applied to a surface of a consumable article and dried, wherein the method comprises formulating the coating composition to include at least one food grade emulsifier/foaming agent.
